(19) United States
(12) Patent Application Publication
(10) Pub. No.: US 2018/0174139 A1
(43) Pub. Date: Jun. 21, 2018

(54) ELECTRONIC SYSTEM AND METHOD FOR PERFORMING A TRANSACTION WITH A MOTOR VEHICLE

(71) Applicant: MASTERCARD INTERNATIONAL INCORPORATED, Purchase, NY (US)

(72) Inventor: Ankur Arora, New Delhi (IN)

(21) Appl. No.: 15/848,907

(22) Filed: Dec. 20, 2017

(30) Foreign Application Priority Data
Dec. 21, 2016 (SG) 10201610725T

(51) Int. Cl. G06Q 20/38; G06Q 20/36; G06Q 20/32; G06Q 20/40; G06Q 20/20; H04W 4/44

(52) U.S. Cl. CPC G06Q 20/3821; G06Q 20/3674; G06Q 20/3278; G06Q 30/06; G06Q 20/20; H04W 4/44; G06Q 20/40

(57) ABSTRACT

The present disclosure generally relates to an electronic system, a computerized method implemented on a merchant server of the electronic system, and a non-transitory computer-readable medium storing computer-readable instructions for performing a transaction between a merchant and a motor vehicle of a customer, the motor vehicle located within the vicinity of the merchant. Steps of the method include receiving, from the motor vehicle, identification data of the motor vehicle, communicating, to the motor vehicle, details of products/services provided by the merchant, receiving, from the motor vehicle, a request for one or more products/services selected by the customer, obtaining details of a payment instrument of the customer, and performing a payment process for the selected products/services with the payment instrument details.

### CROSS REFERENCE TO RELATED APPLICATIONS

This patent application claims priority to Singapore Application No. 10201610725T filed on Dec. 21, 2016, the disclosure of which is incorporated by reference herein in its entirety as part of the present application.

### BACKGROUND

The present disclosure generally relates to an electronic system and method for performing a transaction with a motor vehicle. More particularly, the present disclosure describes various embodiments of an electronic system and method for performing a transaction, e.g. a commerce/business/merchandise transaction, between a merchant and a motor vehicle of a customer, the motor vehicle being located within the vicinity of the merchant.

Customers are increasingly using digital wallets to pay for transactions with merchants, e.g. purchases of merchandise, over conventional cash and cashless payment modes such as credit cards. A digital wallet refers to an electronic device, e.g. a mobile device or phone, which allows a customer to make electronic commerce transactions. A payment instrument of the customer, e.g. financial/bank account or a credit card may be linked to the digital wallet such that payments to merchants are made from the linked payment instrument.

Customers who drive may make transactions or purchases related to their motor vehicles, such as for fuel, parking charges, toll charges, car insurance, car servicing and speeding and parking infringements. For example, a customer may drive his/her motor vehicle to a petrol station/kiosk for refueling. However, one problem is that after the refueling has been completed, the customer is required to step out of the motor vehicle and enter the store in the petrol station in order to pay for the fuel or to purchase other items from the store.

Therefore, in order to address or alleviate at least the aforementioned problem/disadvantage, there is a need to provide an electronic system and method for performing a transaction between a merchant and a motor vehicle of a customer, in which there is at least one improved feature over the aforementioned prior art.

### BRIEF DESCRIPTION

A first aspect of the present disclosure provides an electronic system, a computerized method implemented on a merchant server of the electronic system, and a non-transitory computer-readable medium storing computer-readable instructions for performing a transaction between a merchant and a motor vehicle of a customer, the motor vehicle located within the vicinity of the merchant. Steps of the method include receiving, from the motor vehicle, identification data of the motor vehicle, communicating, to the motor vehicle, details of products/services provided by the merchant, receiving, from the motor vehicle, a request for one or more products/services selected by the customer, obtaining details of a payment instrument of the customer, and performing a payment process for the selected products/services with the payment instrument details.

A second aspect of the present disclosure provides a vehicle electronic system of a motor vehicle of a customer, a computerized method implemented on the vehicle electronic system, and a non-transitory computer-readable medium storing computer-readable instructions for performing a transaction between a merchant and a motor vehicle of a customer, the motor vehicle located within the vicinity of the merchant. Steps of the method include communicating, to a merchant server, identification data of the motor vehicle, receiving, from the merchant server, details of products/services provided by the merchant, and communicating, to the merchant server, a request for one or more products/services selected by the customer, wherein details of a payment instrument of the customer are obtained by the merchant server, and wherein a payment process for the selected products/services is performed by the merchant server with the payment instrument details.

An advantage of one or more of the above aspects of the present disclosure is that the customer can transact with and pay the merchant with the customer's payment instrument while remaining inside the motor vehicle. After completion of the payment process, the merchant may deliver the selected products/services to the motor vehicle, allowing the customer to receive the products/services without having to leave the motor vehicle. The processing of transactions with merchants relating to or purchased from a motor vehicle is thus significantly improved and customer experience is enhanced.

An electronic system and method for performing a transaction between a merchant and a motor vehicle of a customer according to the present disclosure is thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1 is an illustration of a system for implementation of a method for performing a transaction between a merchant and a motor vehicle of a customer, in accordance with embodiments of the present disclosure.

FIG. 2 is a flowchart illustration of a method implemented on an electronic system for performing a transaction between the merchant and a motor vehicle of a customer, in accordance with embodiments of the present disclosure.

FIG. 3 is a flowchart illustration of a method implemented on a vehicle electronic system of a motor vehicle of a customer for performing a transaction between a merchant and the motor vehicle, in accordance with embodiments of the present disclosure.

FIG. 4 is a block diagram illustration of the technical architecture of a merchant server, in accordance with embodiments of the present disclosure.

FIG. 5 is a block diagram illustration of the technical architecture of a vehicle electronic system, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to an electronic system and method for performing a transaction between a merchant and a motor vehicle of a customer, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications, and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

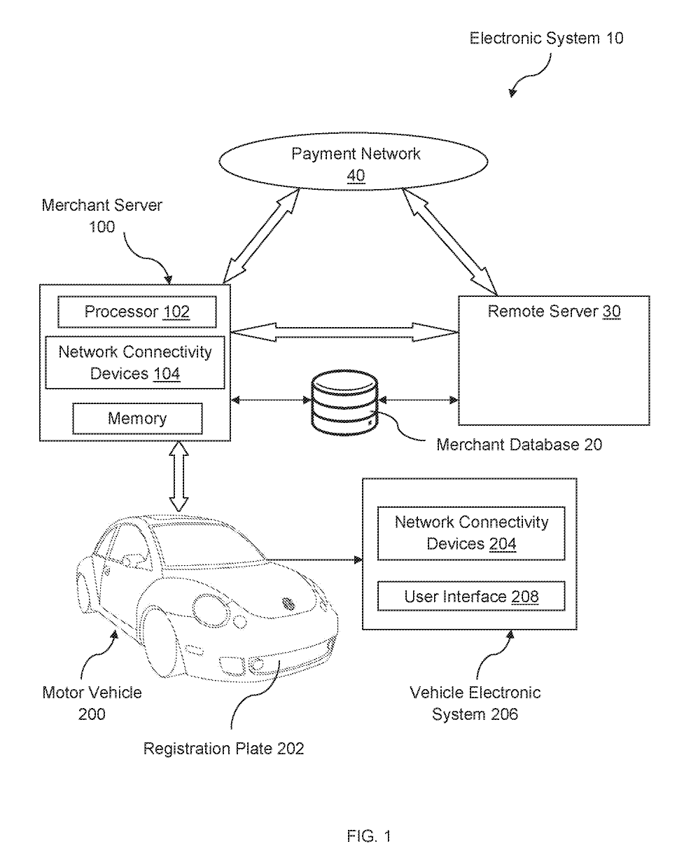

In representative or exemplary embodiments of the present disclosure, there is provided an electronic system 10 as illustrated in FIG. 1. The electronic system 10 includes a merchant server 100 having a processor 102 and memory configured to store computer-readable instructions for executing a method for performing a transaction between a merchant and a motor vehicle of a customer, according to embodiments of the present disclosure. The electronic system 10 further includes a motorized/motor vehicle 200 of the customer, such as a car, van, truck, bus, caravan, motorhome, motorbike, bicycle, boat, train, aeroplane, helicopter, or other vehicle/mobility device. The motor vehicle 200 includes a vehicle/identification number that may be displayed on a license or registration plate 202 of the vehicle.

The motor vehicle 200 may be enabled or equipped with internet connectivity/access. The internet-enabled motor vehicle 200 allows the motor vehicle 200 to share internet access with other electronic devices both inside and outside the motor vehicle 200, such as via a wireless local area network. The motor vehicle 200 may include one or more communications/network connectivity devices 204, e.g. a Wi-Fi or radio transceiver module, for communication with other communications/electronic devices.

The motor vehicle 200 may further include a vehicle electronic system 206 that is integrated with or installed inside the motor vehicle 200 as a part thereof or fitted thereto (either on manufacture or during a retrofit). The vehicle electronic system 206 is operative for performing a transaction between the motor vehicle 200 and the merchant. The vehicle electronic system 206 may be operable by the customer with a user interface 208 inside the motor vehicle 200. For example, the user interface 208 may include a touch-sensitive display screen on the dashboard. The user interface 208 may additionally include other input devices, such as biometric sensors, disposed on the dashboard, center console, steering wheel, doors, or other parts of the interior of the motor vehicle 200. The vehicle electronic system 206 includes or is communicatively linked to the network connectivity devices 204, such that the customer is able to control data communications via the internet with the user interface 208.

The vehicle electronic system 206 of the motor vehicle 200 may be linked to a customer payment instrument, such as a payment card. The term “payment instrument” may refer to any suitable cashless payment mechanism, such as a credit card, a debit card, a prepaid card, a charge card, a membership card, a promotional card, a frequent flyer card, an identification card, a gift card, and/or any other payment cards that may hold payment card information (e.g. details of user account or payment card) and which may be stored electronically on the vehicle electronic system 206. A payment instrument such as a payment card or credit card may be issued by an issuer financial institution or bank. The vehicle electronic system 206 may thus include a digital wallet stored thereon that allows the customer to make electronic commerce transactions with merchants. Alternatively or additionally, a digital wallet may be stored on a remote (e.g. cloud) server and accessed via the internet. Transactions with merchants may be paid for with the payment instrument which may be linked to the digital wallet, such as for purchases via the merchant server 100 that is configured to accept digital or electronic payments. The digital wallet may be operated on a software application executable on the vehicle electronic system 206 and controllable by the customer via the user interface 208.

While it is envisaged that the digital wallet may be linked to at least one payment instrument of the customer, it will be appreciated that the digital wallet may alternatively be configured to receive pre-paid funds or be recharged/reloaded with funds (e.g. from a financial or bank account of the customer). In this way, the customer may select an amount to pay into the digital wallet (e.g. on an ad hoc or periodic basis).

The motor vehicle 200 may thus be configured with a digital wallet stored on the vehicle electronic system 206, or alternatively on a remote/cloud server, for performing transactions with merchants. The digital wallet may be associated with the vehicle registration number and/or other identification data of the motor vehicle 200/vehicle electronic system 206. For example, the digital wallet may be associated with a unique media access control (MAC) address of the vehicle electronic system 206. The association of the digital wallet with the identification data, e.g. the vehicle registration number and/or MAC address, may be stored or recorded on a wallet database 20. The wallet database 20 may form part of or be connected to the merchant server 100, or alternatively the wallet database 20 may reside on a remote server 30 of the electronic system 10.

In some alternative embodiments, no digital wallet may be used on the motor vehicle 200. Instead, payments may be made via the vehicle electronic system 206 by a customer entering or inputting details of a payment instrument, e.g. credit card, on the user interface 208.

The merchant server 100 may include one or more communications/network connectivity devices 104 for providing internet connectivity/access to the merchant. It will be appreciated that the merchant server 100 may be communicable with the motor vehicle 200, specifically the vehicle electronic system 206 thereof, via the network connectivity devices 104 and 204. The network connectivity devices 204 may include a beacon device for detection by nearby electronic devices or systems, such as the vehicle electronic system 206 of the motor vehicle 200. It will be appreciated that the vehicle electronic system 206 may communicate with the beacon device via the network connectivity device 204 of the motor vehicle 200. The beacon device of the merchant server 100 continuously or intermittently broadcasts an identification data signal or data packet that enables a nearby electronic device to ping and detect the presence of the beacon device. The beacon device may be configured for one or more communications protocol, such as Wi-Fi and Bluetooth low energy (BLE).

Further, the merchant server 100 may be communicatively linked to a payment network 40 of the electronic system 10 for processing payments of transactions. The merchant server 100 may communicate via the network connectivity devices 104 with the payment network 40. It would be readily understood that the payment process may be completed in a standard manner which may involve various parties of the payment network 40, such as the issuer and acquirer financial institutions/banks of the customer and merchant, respectively. Accordingly, the payment network 40 links together financial institutions (e.g. banks and credit card institutions) associated with financial/bank accounts of the merchant and with payment cards (e.g. credit cards) or other payment instruments of the customer.

It will be appreciated that the payment network 40 may be operated by an organization such as a payment card or credit card association. Further, the remote server 30 may be communicatively linked to the payment network 40, or it may alternatively be interpreted that the remote server 30 is communicatively linked such that it forms part of or is integrally connected within the payment network 40.

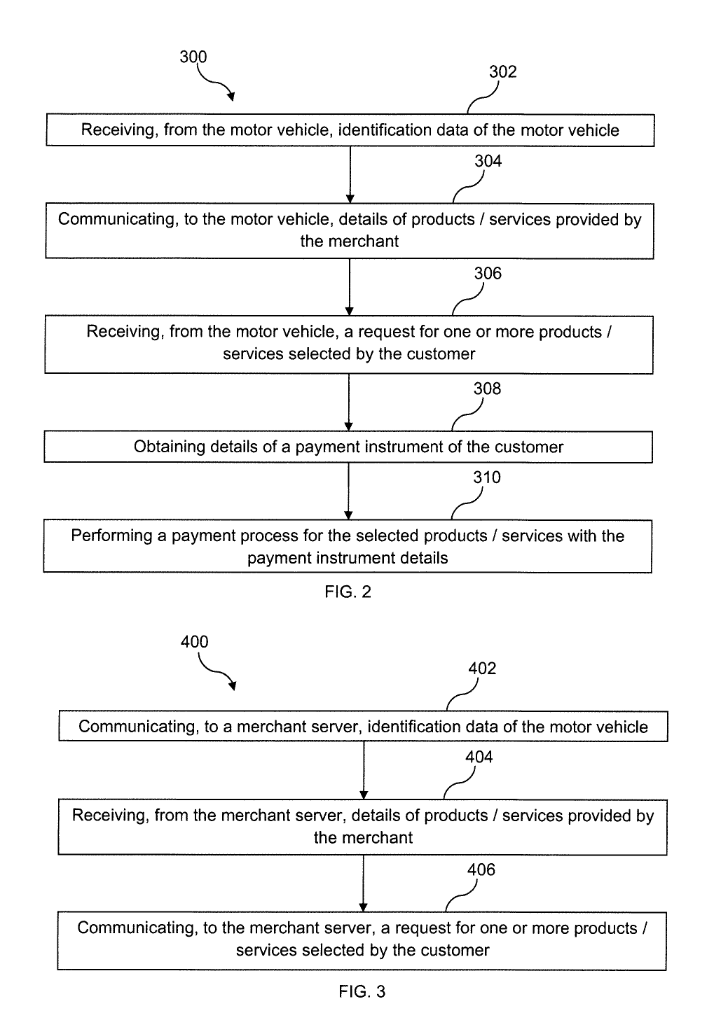

With reference to FIG. 2, there is a computer-implemented or computerized method 300, e.g. implemented on a merchant server 100, for performing a transaction between a merchant and a motor vehicle 200 of a customer. Complementarily, with reference to FIG. 3, there is a computer-implemented or computerized method 400 implemented on a vehicle electronic system 206 of the motor vehicle 200. The customer may drive the motor vehicle 200 to the merchant, e.g. a petrol station or drive-through service, with the intention to purchase one or more products and/or services, e.g. petrol and food. When the motor vehicle 200 is located within the vicinity of the merchant, i.e. proximate to or at the merchant's premises, the customer can use the methods 300 and 400 to perform a transaction with the merchant and purchase the required products/services.

In various embodiments of the present disclosure, the method 300 includes:

a. a step 302 of receiving, from the motor vehicle 200, identification data of the motor vehicle 200;

b. a step 304 of communicating, to the motor vehicle 200, details of products/services provided by the merchant;

c. a step 306 of receiving, from the motor vehicle 200, a request for one or more products/services selected by the customer;

d. a step 308 of obtaining details of a payment instrument of the customer; and

e. a step 310 of performing a payment process for the selected products/services with the payment instrument details.

In various embodiments of the present disclosure, the method 400 includes:

a. a step 402 of communicating, to a merchant server 100, identification data of the motor vehicle 200;

b. a step 404 of receiving, from the merchant server 100, details of products/services provided by the merchant; and

c. a step 406 of communicating, to the merchant server 100, a request for one or more products/services selected by the customer.

When the motor vehicle 200 is in the vicinity of the merchant, e.g. within a wireless communication range or within visual range of the merchant, the motor vehicle 200 performs the step 402 of communicating identification data to the merchant server 100. The merchant server 100 concurrently performs the step 302 of receiving the identification data from the motor vehicle 200. For example, the identification data may include or be represented by the vehicle registration number. The electronic system 10 may include an optical device communicatively linked to the merchant server 100 for scanning motor vehicles 200 in the vicinity of the merchant. The optical device may include an image capture device or camera for capturing images of the motor vehicles 200 within visual range of the camera. Specifically, for each motor vehicle 200, the camera may focus on and capture an image of the vehicle registration number displayed on the registration plate 202 thereof. The identification data may be embedded in the captured image of the vehicle registration number. It will be appreciated that the captured image may be of the registration plate 202 at the front and/or rear of the motor vehicle 200. In the step 302, the merchant server 100 receives the identification data in the form of digital image data from the camera.

Alternatively or additionally, the identification data may include or be represented by the MAC address of the vehicle electronic system 206 installed inside the motor vehicle 200. The identification data may optionally include or be represented by at least one of the vehicle registration number, vehicle make/model, year of vehicle registration/manufacture, and ownership details (e.g. name/address of the customer) of the motor vehicle 200.

The identification data may be carried by a data signal or data packet that is continuously or intermittently broadcasted by the vehicle electronic system 206, e.g. via the communications device 204. The data signal broadcasted by the vehicle electronic system 206 seeks out or searches for other data signals broadcasted by the beacon device of the merchant server 100, similar to how mobile devices/phones would search for Wi-Fi signals. When the beacon device is within a broadcast range of the vehicle electronic system 206, i.e. the vehicle electronic system 206 is also within a broadcast range of the beacon device, the data signal from the vehicle electronic system 206 can communicate with the identification data signal broadcasted from the beacon device, thereby enabling the vehicle electronic system 206 to automatically detect the beacon device. The proximity engagement of the vehicle electronic system 206 and the beacon device when they are proximate to each other may occur through known technologies such as Wi-Fi Aware, Bluetooth Smart, and iBeacon.

When the vehicle electronic system 206 and the beacon device are within each other's broadcast range, both devices engage and become communicative with each other. The data signal that is broadcasted by the vehicle electronic system 206 is communicated, via the beacon device, to the merchant server 100. The merchant server 100 also receives the identification data that is carried by the broadcasted data signal. The MAC address of the vehicle electronic system 206 may subsequently be extracted by the merchant server 100 from the identification data. The MAC address enables the merchant server 100 to uniquely identify the vehicle electronic system 206 and consequently the motor vehicle 200 in which the vehicle electronic system 206 is installed.

If there are multiple motor vehicles 200 within the vicinity of the merchant, the merchant server 100 would be able to receive identification data from each motor vehicle 200, e.g. through automatic scanning of the merchant premises with the optical device or detection with the beacon device. The merchant sever 100 may uniquely identify each motor vehicle 200 for performing a transaction therewith based on the method 300.

After receiving the identification data from the motor vehicle 200, as well as from other motor vehicles 200 in the vicinity, the merchant server 100 would be able to uniquely identify the motor vehicle 200 for the step 304. In the step 304, the merchant server 100 communicates details of the products/services to the motor vehicle 200. The motor vehicle 200 correspondingly performs the step 404 of receiving the details of the products/services. The communication may occur between the network connectivity devices 104 and 204 of the merchant server 100 and motor vehicle 200, respectively. Details of the products/services may include a list of the products and/or services provided by the merchant, such as goods, items, articles, merchandise, etc. which may be purchased by the customer. Some of the services provided by the merchant may include car-wash and refueling for example if the motor vehicle 200 is in a petrol station. Other examples of the products/services may include or relate to, but are not limited to, in-vehicle entertainment and in-vehicle concierge services, such as restaurant booking, gift ordering, and purchasing of entertainment tickets. Promotions, advertisements, offers, rebates, and/or discounts associated with the products/services may also be communicated to the motor vehicle 200 for the customer's awareness.

In some embodiments, the products/services may be unrelated to vehicle needs and may instead include food, beverage, clothing, consumer goods, electronics, etc. It will be appreciated that various types of products/services may be provided by merchants depending on the business of the merchants. In some other embodiments, the transactions relate to parking charges, toll charges, vehicle insurance, vehicle servicing, speeding and parking infringements (or other police-administered fines), wherein the merchant may be a government agency/organization instead of a commercial business entity.

The details of the products/services may be displayed on the user interface 208 inside the motor vehicle 200, such that the customer is able to browse through and select the products/services he/she intends to purchase while remaining inside the motor vehicle 200. The customer uses the user interface 208 to select the products/services and submit a request for the selected products/services. The request represents an intention of the customer to purchase one of more products/services from the merchant. The request is communicated from the motor vehicle 200 to the merchant server 100 in the step 406.

After receiving the request in the step 306, the merchant server 100 proceeds to perform the step 308 of obtaining details of a payment instrument of the customer. The payment instrument details may be provided by the customer by keying or ‘tapping’ on ‘buttons’ on the user interface 208 of the motor vehicle 200. The payment instrument details are subsequently communicated from the motor vehicle 200 to the merchant server 100.

In some alternative embodiments, the merchant server 100 may optionally perform a step of identifying a digital wallet based on the identification data received from the motor vehicle 200 in the step 302. The digital wallet may be stored on the vehicle electronic system 206 of the motor vehicle 200, and as such the digital wallet may be associated with and identifiable by the identification data of the motor vehicle 200. This step may further include retrieving details of the digital wallet from the wallet database 20. Specifically, the merchant server 100 may identify the digital wallet and retrieve details thereof by searching through the wallet database 20 with the identification data. Alternatively, the merchant server 100 may communicate the identification data to the remote server 30 for the remote server 30 to perform the search. The digital wallet is associated with or linked to a payment instrument of the customer.

It will be appreciated that customers have pre-established customer profiles stored on the wallet database 20. Each customer profile would indicate the associations or connections between the customer's digital wallet, customer's payment instrument, and identification data of the customer's motor vehicle 200. The customer profile may be set up for the first time via the user interface 208 or via other computing devices. Thus, from the search results of the wallet database 20, the merchant server 100 would be able to identify the digital wallet based on the identification data and retrieve details of the digital wallet.

The retrieval of the digital wallet details may be performed automatically by the merchant server 100 in response to or simultaneously with the step 306 of receiving the request of selected products/services from the motor vehicle 200. Accordingly, when the customer submits the request, the request also includes an approval by the customer for the merchant server 100 to retrieve the digital wallet details. Alternatively after the step 306, the merchant server 100 may communicate an approval or confirmation request to the motor vehicle 200, requesting the customer to confirm whether to proceed with the purchase of the selected products/services. This approval or confirmation request may further include details of the selected products/services that may be displayed to the customer on the user interface 208. The customer may then proceed to confirm the purchase and communicate the digital wallet details to the merchant server 100. In the step 308, the merchant server 100 may obtain the payment instrument details from the digital wallet details.

After obtaining the payment instrument details in the step 308, the merchant server 100 proceeds to the step 310 of performing the payment process for the selected products/services with the payment instrument details. The payment process may include communicating the payment instrument details from the merchant server 100 to the payment network 40. The payment process would be performed by the payment network 40 in a standard manner readily understood by the skilled person. Additionally, the payment process may include authenticating the payment instrument based on authentication data of the customer.

The authentication data may be provided by the customer via the user interface 208 inside the motor vehicle 200. The authentication data may include an alphanumeric passcode or password (e.g. including or using letters, numbers, punctuation marks, and/or symbols). Alternatively or additionally, the authentication data may include biometric data of the customer. The biometric data may include, but is not limited to, photo of the face, fingerprint(s), retinal information, and/or voice command. The user interface 208 may include the appropriate input devices or biometric sensor for the customer to input, enter, key, or ‘tap’ in the authentication data.

In one embodiment, the payment process further includes the merchant server 100 receiving the authentication data from the motor vehicle 200. The merchant server 100 may be communicatively linked to an authentication database for verifying the authentication data. Alternatively, the authentication database may reside on the remote server 30 or the payment network 40. The merchant server 100 may communicate the authentication data to the remote server 30 for verification against the authentication database. Yet alternatively, the merchant server 100 may communicate the authentication data to the payment network 40 to be verified. It will be appreciated that the authentication database and wallet database 20 may be distinct from each other, or integrated together as a single database.

In another embodiment, the authentication data is communicated by the customer directly from the motor vehicle 200 to the payment network 40. For example, during the payment process after the customer has confirmed his/her purchase of the selected products/services, he/she may receive an authentication request directly from the payment network 40 to verify the payment instrument and whether the customer is the correct person to use the payment instrument for the transaction. The authentication data may be input on the user interface 208 for communication to the payment network 40, and the payment instrument would be authenticated by the payment network 40 based on the authentication data.

In yet another embodiment, the user interface 208, or more broadly the vehicle electronic system 206, may be synchronized or communicatively linked to a mobile device (such as a phone) of the customer. The customer may receive the authentication request from the payment network 40 on the mobile device. Accordingly, the authentication data may be provided by the customer on the mobile device, and the authentication data could then communicated from the mobile device to the payment network 40. It will be appreciated that the mobile device may include biometric sensors for reading biometric data such as fingerprints, iris patterns, heartbeat signals, and the like.

The transaction between the merchant and the customer, specifically performed by the merchant server 100 and motor vehicle 200, ends after the payment process is completed. The customer would have successfully purchased and paid for the selected products/services provided by the merchant, and the merchant would subsequently receive funds from the customer's payment instrument for payment of the selected products/services. The transfer of funds from the payment instrument and the merchant's financial/bank account would take place in a standard manner as readily known to the skilled person in the art. After completing the transaction, the merchant may deliver the selected products/services to the customer while the customer is still inside the motor vehicle 200. In some situations, the products/services may be delivered during the transaction or before the payment process is completed. For example in refueling the motor vehicle 200, the payment process may be performed only after the refueling has been completed.

An advantage of the method 300 is that the customer can transact with and pay the merchant with the customer's payment instrument while remaining inside the motor vehicle 200. The transactions may relate to various products and/or services provided by the merchant, as described in the above examples. The customer may pay for the transactions through input of the payment instrument details within the motor vehicle 200, or alternatively the motor vehicle 200 may be able to function as a commerce platform with an integrated/connected digital wallet of the customer. The motor vehicle 200 is automatically able to connect to merchants as it nears or approaches the vicinity of the merchant, e.g. by forming a wireless communication link with the merchant server 100 or the local area network of the merchant.

The merchant can communicate details of their products/services to the customer by sending them directly to the motor vehicle 200 where they are displayed to the customer on the user interface 208. The customer would be able to browse through the products/services/offers/discounts/promotions/advertisements while remaining inside the motor vehicle 200. The customer can browse through the various attributes and compare them online as well before making an eventual purchase with the merchant. Moreover, during the vehicle's approach towards the merchant, the customer may already be able to view the products/services details even before coming to a complete stop if the motor vehicle 200 has already formed a wireless communication link with the merchant server 100.

After selecting the products/services to purchase from the merchant, the payment can be made directly from the motor vehicle 200, such as by inputting the payment instrument details via the user interface 208 or with a digital wallet integrated with/communicatively linked to the vehicle electronic system 206 of the motor vehicle 200. For security purposes, the payment process may include an authentication step wherein the customer is required to provide authentication data for verifying the payment instrument. The authentication data may include a passcode and/or related to biometrics, such as facial/retina/fingerprint/voice recognition. The payment process would only be completed if the authentication data can be verified. Funds for payment of the selected products/services would be transferred from the payment instrument to the merchant's financial/bank account, as per standard payment transactions.

After completion of the payment process, the merchant may deliver the selected products/services to the motor vehicle 200. The customer can thus receive the products/services without having to leave the motor vehicle 200. It will be appreciated that the merchant delivery may relate to any deliverables requested/paid for by the customer.

Embodiments of the present disclosure improve the processing of transactions with merchants and relating to or purchased from a motor vehicle 200. The transactions can be requested and performed electronically in a quick and easy manner with the customer being able to purchase products/services from the comfort of his/her motor vehicle 200. For payment of parking charges, fees, tolls etc., the transactions can be requested and performed at the time the charges are incurred. The merchant can directly deliver to the motor vehicle 200 while the customer remains inside and without the customer having to interact with the merchant. Customer experience is thus enhanced as a result of the convenience offered to the customer.

The following is a description of the technical architecture of the merchant server 100 and vehicle electronic system 206.

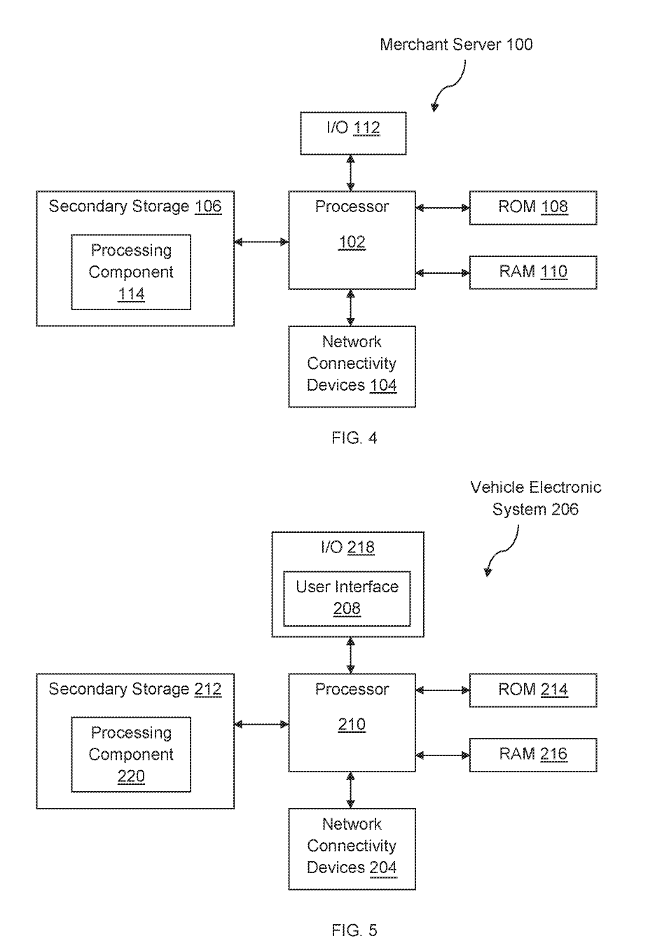

FIG. 4 illustrates a block diagram showing a technical architecture of the merchant server 100. The technical architecture includes a processor 102 (which may be referred to as a central processor unit or CPU) that is in communication with memory or memory devices, e.g. including secondary storage 106 (such as disk drives or memory cards), read only memory (ROM) 108, and random access memory (RAM) 110. The processor 102 may be implemented as one or more CPU chips. The technical architecture further includes input/output (I/O) devices 112, and the network connectivity devices 104 described above.

The secondary storage 106 typically includes a memory card or other storage device and is used for non-volatile storage of data and as an over-flow data storage device if RAM 110 is not large enough to hold all working data. Secondary storage 106 may be used to store programs which are loaded into RAM 110 when such programs are selected for execution.

The secondary storage 106 has a processing component 114, including non-transitory instructions operative by the processor 102 to perform various operations of the method 300 according to various embodiments of the present disclosure. The ROM 108 is used to store instructions and perhaps data which are read during program execution. The secondary storage 106, the ROM 108, and/or the RAM 110 may be referred to in some contexts as computer-readable storage media and/or non-transitory computer-readable media. Non-transitory computer-readable media include all computer-readable media, with the sole exception being a transitory propagating signal per se.

The I/O devices 112 may include printers, video monitors, liquid crystal displays (LCDs), plasma displays, touch screen displays, keyboards, keypads, switches, dials, mice, track balls, voice recognizers, card readers, paper tape readers, and/or other well-known input devices.

The network connectivity devices 104 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 104 may enable the processor 102 to communicate with the Internet or one or more intranets. With such a network connection, it is contemplated that the processor 102 might receive information from the network, or might output information to the network in the course of performing the operations or steps of the method 300. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 106), flash drive, ROM 108, RAM 110, or the network connectivity devices 104. While only one processor 102 is shown, multiple processors may be present. Thus, while instructions may be discussed as executed by a processor, the instructions may be executed simultaneously, serially, or otherwise executed by one or multiple processors.

For purpose of brevity, it will be appreciated that various aspects of the technical architecture of the merchant server 100 may be similar or analogous to the technical architecture of the vehicle electronic system 206 of the motor vehicle 200. Briefly, with reference to FIG. 5, the technical architecture of the vehicle electronic system 206 includes a processor 210 that is in communication with memory or memory devices, e.g. including secondary storage 212 (such as disk drives or memory cards), read only memory (ROM) 214, and random access memory (RAM) 216. The processor 102 may be implemented as one or more CPU chips. The technical architecture also includes input/output (I/O) devices 218 which includes the user interface 208, and further includes the network connectivity devices 204 described above. The secondary storage 212 has a processing component 220, including non-transitory instructions operative by the processor 210 to perform various operations of the method 400 according to various embodiments of the present disclosure.

It will be appreciated that the technical architecture of the merchant server 100 and vehicle electronic system 206 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the merchant server 100/vehicle electronic system 206, at least one of the CPU 102/210, the ROM 108/214, and the RAM 110/216 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by well-known design rules.

In the foregoing detailed description, embodiments of the present disclosure in relation to an electronic system and method for performing a transaction between a merchant and a motor vehicle of a customer are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic system for performing a transaction between a merchant and a motor vehicle of a customer, the motor vehicle located within the vicinity of the merchant, the electronic system including a merchant server comprising:
a processor and a memory configured to store computer-readable instructions, wherein when the instructions are executed, the processor performs steps comprising:
receiving, from the motor vehicle, identification data of the motor vehicle;
communicating, to the motor vehicle, details of at least one of one or more products and services provided by the merchant;
receiving, from the motor vehicle, a request for one or more products and services selected by the customer;
obtaining details of a payment instrument of the customer; and
performing a payment process for the selected one or more products and services with the payment instrument details.

2. The electronic system according to claim 1, wherein the payment instrument details are received by the merchant server from the motor vehicle.

3. The electronic system according to claim 1, the steps further comprising identifying a digital wallet associated with the motor vehicle based on the identification data, wherein the payment instrument is linked to the digital wallet.

4. The electronic system according to claim 3, wherein identifying the digital wallet comprises retrieving details of the digital wallet from a wallet database.

5. The electronic system according to claim 4, wherein obtaining the payment instrument details comprises retrieving the payment instrument details from the digital wallet details.

6. The electronic system according to claim 1, wherein the payment process comprises communicating the payment instrument details from the merchant server to a payment network.

7. The electronic system according to claim 6, wherein the payment process further comprises authenticating the payment instrument based on authentication data of the customer.

8. The electronic system according to claim 7, wherein the payment process further comprises receiving, by the merchant server, the authentication data from the motor vehicle.

9. The electronic system according to claim 8, wherein the payment process further comprises communicating the authentication data from the merchant server to the payment network.

10. The electronic system according to claim 7, wherein the authentication data is communicated by the customer to the payment network.

11. The electronic system according to claim 1, wherein the identification data is embedded in an image of a vehicle registration number of the motor vehicle.

12. The electronic system according to claim 11, further comprising an optical device communicatively linked to the merchant server for capturing the image.

13. The electronic system according to claim 1, wherein the identification data is carried by a data signal broadcasted from a communications device of the motor vehicle.

14. The electronic system according to claim 13, further comprising a beacon device communicatively linked to the merchant server, wherein the broadcasted data signal automatically detects the beacon device when the beacon device is within a broadcast range of the communications device of the motor vehicle.

15. A computerized method implemented on a merchant server for performing a transaction between a merchant and a motor vehicle of a customer, the motor vehicle located within the vicinity of the merchant, the method comprising:
receiving, from the motor vehicle, identification data of the motor vehicle;
communicating, to the motor vehicle, details of at least one of one or more products and services provided by the merchant;
receiving, from the motor vehicle, a request for one or more products and services selected by the customer;
obtaining details of a payment instrument of the customer; and
performing a payment process for the selected one or more products and services with the payment instrument details.

16. The method according to claim 15, wherein the payment instrument details are received by the merchant server from the motor vehicle.

17. The method according to claim 15, the steps further comprising identifying a digital wallet associated with the motor vehicle based on the identification data, wherein the payment instrument is linked to the digital wallet.

18. The method according to claim 17, wherein identifying the digital wallet comprises retrieving details of the digital wallet from a wallet database.

19. The method according to claim 18, wherein obtaining the payment instrument details comprises retrieving the payment instrument details from the digital wallet details.

20-28. (canceled)

29. A non-transitory computer-readable medium storing computer-readable instructions that, when executed, cause a processor of a merchant server to perform steps of a method for performing a transaction between a merchant and a motor vehicle of a customer, the motor vehicle located within the vicinity of the merchant, the steps comprising:
receiving, from the motor vehicle, identification data of the motor vehicle;
communicating, to the motor vehicle, details of at least one of one or more products and services provided by the merchant;
receiving, from the motor vehicle, a request for one or more products and services selected by the customer;
obtaining details of a payment instrument of the customer; and
performing a payment process for the selected one or more products and services with the payment instrument details.

30-32. (canceled)
